(19) United States
(12) Patent Application Publication
(10) Pub. No.: US 2009/0128456 A1
(43) Pub. Date: May 21, 2009

(54) PLASMA DISPLAY PANEL AND DRIVING METHOD THEREOF

(76) Inventor: Joo-Yul Lee, Suwon-si (KR)

Correspondence Address: CHRISTIE, PARKER & HALE, LLP, PO BOX 7068, PASADENA, CA, 91109-7068, US

(21) Appl. No.: 12/266,410

(22) Filed: Nov. 6, 2008

(30) Foreign Application Priority Data
Nov. 16, 2007 (KR) 10-2007-0117519

(51) Int. Cl. G09G 3/28; G09G 5/10

(52) U.S. Cl. 345/63; 345/690; 345/211

(57) ABSTRACT

A driving method for a plasma display panel to improve brightness when the load is low is provided. The driving method of the plasma display panel includes allocating a first number of sustain pulses for driving the plasma display panel when a load of the plasma display panel exceeds a reference load. The first number of sustain pulses is allocated as a function of a power consumption of the plasma display panel. The method further includes allocating a second number of sustain pulses for driving the plasma display panel when the load is less than the reference load. The second number of sustain pulses is allocated to improve brightness.

### CROSS-REFERENCE TO RELATED APPLICATIONS

This application claims priority to and the benefit of Korean Patent Application No. 10-2007-0117519, filed on Nov. 16, 2007, in the Korean Intellectual Property Office, the entire content of which is incorporated herein by reference.

### BACKGROUND OF THE INVENTION

1. Field of the Invention

The present invention relates to a plasma display panel and a driving method thereof for increasing a brightness of the plasma display panel.

2. Discussion of Related Art

A plasma display panel (hereinafter, referred to as “PDP”) displays an image by causing phosphor to emit light using ultraviolet rays of 147 nm generated during the discharge of an inert gas mixture. The PDP can be easily made thin and large and provides a remarkably enhanced image quality due to recent technological developments.

The PDP is driven by dividing a single frame into several sub-fields with different time periods of light emission for the implementation of gray levels of an image. Each of the sub-fields is divided into a reset period, an address period for selecting a cell to be turned on, and a sustain period for implementing gray levels based on discharge times.

The PDP maintains power consumption regardless of a load of the panel using an automatic power control (hereinafter, referred to as “APC”). When the load of the panel is high (that is, when many discharge cells are turned on), the number of sustain pulses allocated during the sustain period is set to a small value. When the load of the panel is low (that is, when few discharge cells are turned on), the number of the sustain pulses allocated during the sustain period is set to a large value so that the power consumption is maintained uniformly regardless of the load of the panel.

FIG. 1 is a graph illustrating an operation of a conventional APC. Referring to FIG. 1, the conventional APC maintains the power consumption by reducing the number of the sustain pulses as the load is increased in response to the load of the panel when the load of the panel is greater than a specific load. Since the number of the sustain pulses is reduced as the load of the panel is increased, brightness decreases as the load of the panel increases.

The specific load as a reference value for maintaining the power consumption uniform to a degree is determined by considering the stress and the power consumption of a driving unit. The specific load may be determined based on the size and resolution of the panel and a driving unit used for the panels. Hereinafter, for the convenience of illustration, the specific load is referred to as a knee point. The specific load may also be referred to as a reference load.

The conventional APC maintains the number of sustain pulses uniformly when the load of the panel is less than the knee point. When the load of the panel increases past the knee point, the APC gradually reduces the number of sustain pulses to maintain a uniform power consumption. Therefore, the power consumption gradually increases up to the knee point of the panel and maintains a uniform value to a degree in response to the load of the panel as the load increases past the knee point.

However, when the number of sustain pulses is maintained uniformly as the load of the panel decreases to less than the knee point, brightness cannot be sufficiently expressed.

### SUMMARY OF THE INVENTION

Accordingly, in exemplary embodiments of the present invention, a plasma display device and a driving method are provided for improving brightness when a panel load is low.

In an exemplary embodiment of the present invention, a driving method of a plasma display panel is provided including allocating a first number of sustain pulses for driving the plasma display panel when a load of the plasma display panel exceeds a reference load. The first number of sustain pulses are allocated as a function of a power consumption of the plasma display panel. The driving method further includes allocating a second number of sustain pulses for driving the plasma display panel when the load is less than the reference load. The second number of sustain pulses being allocated to improve brightness.

In one exemplary embodiment, the second number of sustain pulses is allocated such that the second number of sustain pulses increases as the load decreases.

In one exemplary embodiment, the driving method further includes dividing a load region less than the reference load into a plurality of steps; and setting the second number of sustain pulses to be linearly changed in correspondence with the plurality of steps.

In one exemplary embodiment, when the load is changed by at least three steps among the plurality of steps from a first load to a second load, the second number of sustain pulses corresponding to a third load is supplied at least once prior to supplying the second number of sustain pulses corresponding to the second load, wherein the third load is between the first load and the second load.

In one exemplary embodiment, the first number of sustain pulses is allocated such that the first number of sustain pulses decreases as the load increases.

In an exemplary embodiment of the present invention, a plasma display device is provided including an inverse gamma compensator for performing inverse gamma correction on video data; a frame memory for storing the video data on which the inverse gamma correction is performed; an automatic power controller for adjusting a number of sustain pulses using the video data stored in the frame memory; and a panel for displaying an image using the number of the sustain pulses determined by the automatic power controller. The automatic power controller detects a load of the panel using the video data, adjusts the number of the sustain pulses as a function of a power consumption of the panel when the load exceeds a reference load, and adjusts the number of the sustain pulses when the load is less than the reference load to improve a brightness of the panel.

In one exemplary embodiment, the automatic power controller is configured to increase the number of the sustain pulses as the load of the panel decreases when the load is less than the reference load.

In one exemplary embodiment, the automatic power controller is configured to linearly increase the number of the sustain pulses in correspondence with a decrease of the load when the load is less than the reference load.

In one exemplary embodiment, the automatic power controller is configured to decrease the number of the sustain pulses as the load increases when the load exceeds the reference load.

### BRIEF DESCRIPTION OF THE DRAWINGS

These and/or other embodiments and features of the invention will become apparent and more readily appreciated from the following description of exemplary embodiments, taken in conjunction with the accompanying drawings of which:

FIG. 1 is a graph illustrating curves of brightness and power consumption by a conventional automatic power controller;

FIG. 2 is a block diagram of a plasma display device according to an exemplary embodiment of the present invention;

FIG. 3 is a view illustrating the number of sustain pulses adjusted in a region where the panel load is less than that of a knee point by the automatic power controller of FIG. 2; and

FIG. 4 is a view illustrating a conventional curve of brightness and a curve of brightness according to an exemplary embodiment of the present invention.

### DETAILED DESCRIPTION OF EXEMPLARY EMBODIMENTS

Hereinafter, certain exemplary embodiments according to the present invention will be described with reference to the accompanying drawings. Herein, when a first element is described as being coupled to a second element, the first element may be directly coupled to the second element, or alternatively, may be indirectly coupled to the second element via a third element. Further, some of the elements that are not essential to the complete understanding of the invention are omitted for clarity. Also, like reference numerals refer to like elements throughout.

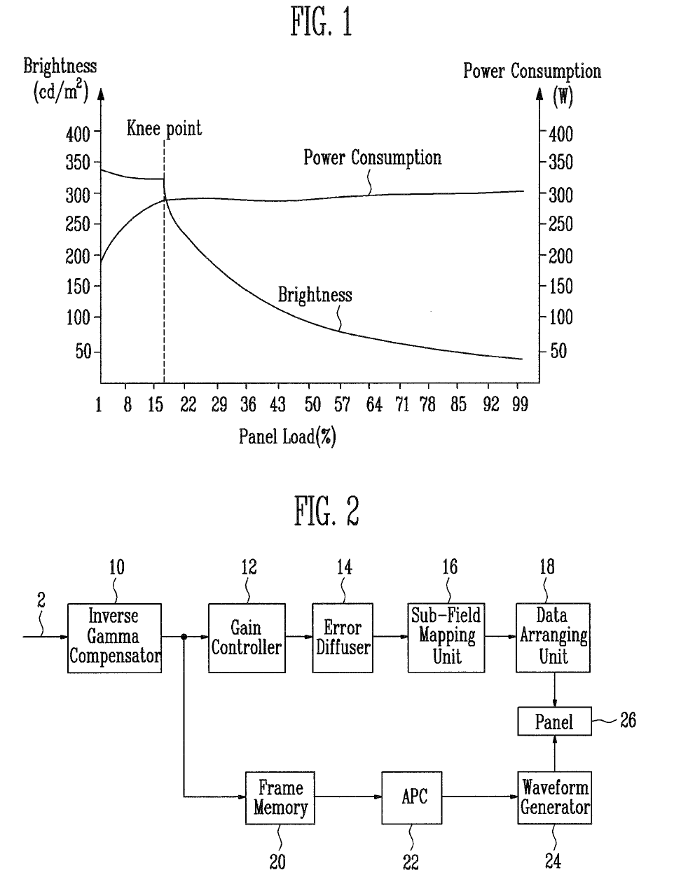

FIG. 2 is a block diagram of a plasma display device according to an exemplary embodiment of the present invention. In an exemplary embodiment, a driving unit of the plasma display device in FIG. 2 is employed. However, the present invention is not thus limited.

Referring to FIG. 2, the plasma display device according to an exemplary embodiment of the present invention includes an inverse gamma compensator 10 coupled between an input line 2 and a panel 26, a gain controller 12, an error diffuser 14, a sub-field mapping unit 16, a data arranging unit 18, a frame memory 20 coupled between the inverse gamma compensator 10 and the panel 26, an automatic power controller (APC) 22, and a waveform generator 24.

The inverse gamma compensator 10 performs inverse gamma correction on video data on which gamma correction is performed to linearly change the brightness/gray level value of an image signal. The gain controller 12 amplifies the video data compensated by the inverse gamma compensator 10 by an effective gain. The error diffuser 14 diffuses an error component of a discharge cell to adjacent cells to minutely adjust the brightness. The sub-field mapping unit 16 reallocates the video data supplied from the error diffuser 14 by sub-fields. The data arranging unit 18 converts the video data to be suitable to a resolution format of the panel 26 and supplies the converted video data to an address driving unit of the panel 26. The frame memory 20 stores data corresponding to a single frame and supplies the stored data to the APC 22. The APC 22 adjusts the number of sustain pulses corresponding to the load of the panel using data supplied from the frame memory 20. The waveform generator 24 generates a timing control signal corresponding to the number of sustain pulses determined by the APC 22. The waveform generator 24 supplies the generated timing control signal to the address driving unit, a scan driving unit, and a sustain driving unit of the panel.

In an exemplary embodiment of the present invention, the APC 22 does not fix the number of sustain pulses when the load of the panel is less than the knee point. That is, the APC 22 determines the number of sustain pulses such that the brightness of the panel can be improved in a region less than the knee point.

Table 1 represents temperatures of the panel corresponding to pairs of the sustain pulses supplied to the panel.

TABLE 1

| | Panel load (pairs | | |
|---|---|---|---|
| | of sustain pulses) | | |
| | 18% (800 pairs) | 1% (800 pairs) | 1% (900 pairs) |
| Temperature (° C.) | 63.056 | 59.016 | 62.592 |

Referring to Table 1, when 800 pairs of the sustain pulses are supplied to drive the panel for a time period (e.g., a predetermined time period) (for example, longer than 30 minutes) at the knee point (or “reference load”) of the panel (the knee point load of the panel is assumed to be 18% in Table 1), the average temperature of the panel is 63.056 degrees centigrade. At a 1% load of the panel, when the panel is driven for a time period (e.g., a predetermined time period) by supplying 800 pairs of the sustain pulses, the average temperature of the panel is 59.016 degrees centigrade.

The average temperature of the panel translates into a stress of the driving unit. More pairs of the sustain pulses can be supplied when the load of the panel is 1% than when the load is higher. In a case where the load of the panel is 1%, the average temperature is 62.592 degrees centigrade when 900 pairs of the sustain pulses are supplied.

Table 1 shows that more sustain pulses than the number of the sustain pulses that are supplied at the knee point can be supplied in a region where the load of the panel is less than the knee point. Therefore, the APC 22 is set to increase the number of sustain pulses as the load of the panel is decreased from the knee point. As such, if the number of the sustain pulses increases as the load of the panel is decreased in a region of load less than that of the knee point, the brightness can be improved.

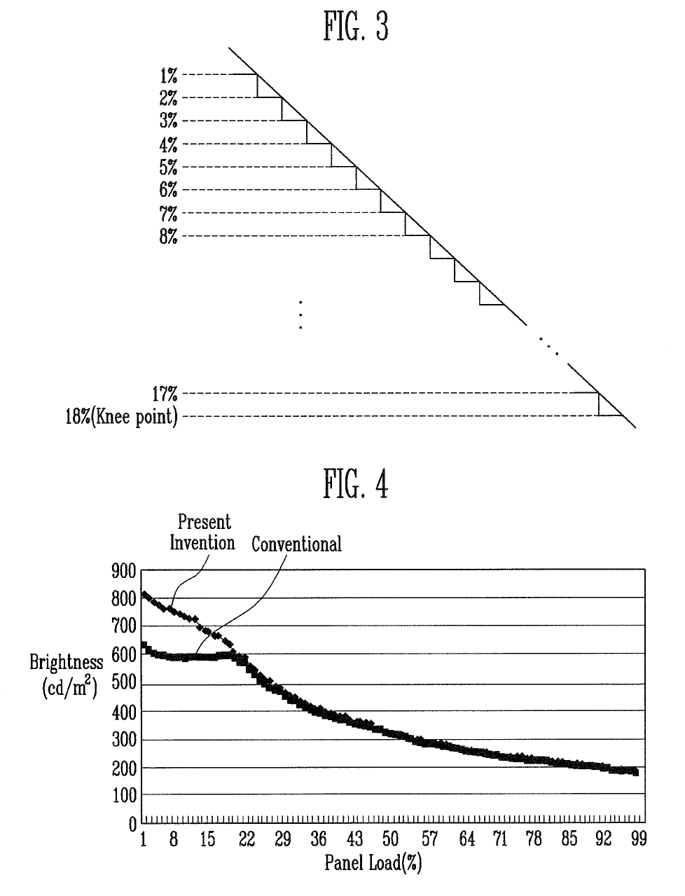

The region of load less than the knee point is divided into plural steps in correspondence with the load of the panel, as illustrated in FIG. 3. The number of the sustain pulses is set to increase as the load of the panel decreases from the knee point (that is, as the load step decreases). As such, when the number of the sustain pulses linearly increases as the panel load decreases from the knee point to a load less than the knee point, the brightness can be improved. Although FIG. 3 illustrates the load steps down by 1% when the load is less than the knee point, exemplary embodiments of the present invention are not thus limited.

In an exemplary embodiment of the present invention, when a step corresponding to the load of the panel is changed by at least three steps or more in a region of load less than the knee point, that is, when the brightness is rapidly changed, the number of the sustain pulses corresponding to a load between the steps is supplied at least once.

By way of example, when the load of the panel is changed from 1% to 8%, the sustain pulses to be supplied to the panel are changed from the number of the sustain pulses corresponding to 1% to the number of the sustain pulses corresponding to 8%. In this case, the brightness is rapidly changed in the panel such that the image quality may be deteriorated. Therefore, in the described exemplary embodiment of the present invention, the number of the sustain pulses (that is, 2% to 7%) positioned between 1% and 8% is supplied between the number of the sustain pulses corresponding to 1% and the number of the sustain pulses corresponding to 8% at least once or more. In other words, in the described exemplary embodiment of the present invention, when the load of the panel is changed by at least three steps, the number of the sustain pulses corresponding to a load between the steps is supplied at least once. By doing so, the brightness of the panel is prevented from being rapidly changed.

In a region with load greater than the knee point, the number of the sustain pulses decreases as the load of the panel increases identical to the conventional case. In other words, in the region of load less than the knee point, the number of the sustain pulses is allocated by considering the stress of the driving unit. Further, in a region of load exceeding the knee point, the number of the sustain pulses is allocated by considering the power consumption.

FIG. 4 and Table 2 illustrate brightness when the APC of exemplary embodiments of the present invention are employed. In Table 2 and FIG. 4, the knee point is assumed to be 18%. Moreover, when the load of the panel is 1%, 100 pairs of additional sustain pulses are supplied than are supplied when the load is at the knee point.

TABLE 2

| | Present invention | Conventional | Improvement of |
|---|---|---|---|
| Load (%) | (cd/m₂) | (cd/m₂) | brightness (cd/m₂) |
| 1 | 816.5719 | 636.4122 | 180.1597 |
| 3 | 788.0078 | 607.2608 | 180.7470 |
| 5 | 788.4074 | 595.6234 | 169.7839 |
| 7 | 752.8924 | 591.4248 | 161.4676 |
| 9 | 740.2837 | 589.5075 | 150.7762 |
| 11 | 725.2227 | 590.7280 | 134.4947 |
| 13 | 690.2253 | 591.7992 | 98.42609 |
| 15 | 670.8043 | 593.0728 | 77.73157 |
| 17 | 651.4451 | 596.6060 | 54.83911 |

Referring to Table 2 and FIG. 4, it can be understood that the brightness is improved over the conventional case in a load region less than the knee point. As such, when the brightness is improved in the load region less than the knee point, a better image can be displayed.

In an exemplary embodiment of the present invention, the number of the sustain pulses is allocated to be gradually decreased as the load of the panel increases to the knee point. That is, according to an exemplary embodiment of the present invention, a high number of the sustain pulses is allocated when the load of the panel is low so that the brightness can be improved.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A driving method of a plasma display panel comprising:
allocating a first number of sustain pulses for driving the plasma display panel when a load of the plasma display panel exceeds a reference load, the first number of sustain pulses being allocated as a function of a power consumption of the plasma display panel; and
allocating a second number of sustain pulses for driving the plasma display panel when the load is less than the reference load, the second number of sustain pulses being allocated to improve brightness.

2. The driving method of a plasma display panel as claimed in claim 1, wherein the second number of sustain pulses is allocated such that the second number of sustain pulses increases as the load decreases.

3. The driving method of a plasma display panel as claimed in claim 2, further comprising:
dividing a load region less than the reference load into a plurality of steps; and
setting the second number of sustain pulses to be linearly changed in correspondence with the plurality of steps.

4. The driving method of a plasma display panel as claimed in claim 3, wherein when the load is changed by at least three steps among the plurality of steps from a first load to a second load, the second number of sustain pulses corresponding to a third load is supplied at least once prior to supplying the second number of sustain pulses corresponding to the second load, wherein the third load is between the first load and the second load.

5. The driving method of a plasma display panel as claimed in claim 1, wherein the first number of sustain pulses is allocated such that the first number of sustain pulses decreases as the load increases.

6. A plasma display device, comprising:
an inverse gamma compensator for performing inverse gamma correction on video data;
a frame memory for storing the video data on which the inverse gamma correction is performed;
an automatic power controller for adjusting a number of sustain pulses using the video data stored in the frame memory; and
a panel for displaying an image using the number of the sustain pulses determined by the automatic power controller,
wherein the automatic power controller detects a load of the panel using the video data, adjusts the number of the sustain pulses as a function of a power consumption of the panel when the load exceeds a reference load, and adjusts the number of the sustain pulses when the load is less than the reference load to improve a brightness of the panel.

7. The plasma display device as claimed in claim 6, wherein the automatic power controller is configured to increase the number of the sustain pulses as the load of the panel decreases when the load is less than the reference load.

8. The plasma display panel as claimed in claim 7, wherein the automatic power controller is configured to linearly increase the number of the sustain pulses in correspondence with a decrease of the load when the load is less than the reference load.

9. The plasma display device as claimed in claim 6, wherein the automatic power controller is configured to decrease the number of the sustain pulses as the load increases when the load exceeds the reference load.
